(19) United States
(12) Patent Application Publication
(10) Pub. No.: US 2019/0120962 A1
(43) Pub. Date: Apr. 25, 2019

(54) TRANSMISSION/RECEPTION MODULE FOR AN OPTOELECTRONIC SENSOR AND METHOD OF DETECTING OBJECTS

(71) Applicant: SICK AG, WALDKIRCH (DE)

(72) Inventors: Harmut GIMPEL, Waldkirch (DE); Gottfried HUG, Waldkirch (DE)

(21) Appl. No.: 16/164,217

(22) Filed: Oct. 18, 2018

(30) Foreign Application Priority Data
Oct. 20, 2017 (DE) 102017124535.9
Jun. 11, 2018 (EP) 18177007.4

(51) Int. Cl. G01S 17/42; G01S 7/481; G02B 26/10; G01C 3/08

(52) U.S. Cl. CPC G01S 17/42; G01C 3/08; G02B 26/10; G01S 7/4817

(57) ABSTRACT

A transmission/reception module for an optoelectronic sensor is provided that has a light transmitter having a transmission optics and that has a light receiver having a reception optics, wherein an irradiation angle of transmitted light of the light transmitter is smaller than a reception angle of received light incident on the light receiver; the light transmitter and the light receiver are arranged coaxially; and the transmission optics and the reception optics are formed as a common optics. The light transmitter and the light receiver are here indirectly micromechanically connected to one another.

The invention relates to a transmission/reception module for an optoelectronic sensor that has a light transmitter having a transmission optics and that has a light receiver having a reception optics, wherein an irradiation angle of transmitted light of the light transmitter is smaller than a reception angle of received light incident on the light receiver; the light transmitter and the light receiver are arranged coaxially; and the transmission optics and the reception optics are formed as a common optics. The invention further relates to a method of detecting objects in a monitored zone in which a light transmitter transmits transmitted light through a transmission optics into the monitored zone and a light receiver receives received light remitted with the transmitted light in the monitored zone by a reception optics, wherein an angle of irradiation of the transmitted light is smaller than an angle of reception of the received light; wherein the light transmitter and the light receiver are arranged coaxially; and wherein the transmission optics and the reception optics are configured as a common optics.

Many optoelectronic sensors work in accordance with the sensing principle in which a light beam is transmitted into the monitored zone and the light beam reflected by objects is received again in order then to electronically evaluate the received signal. The time of flight is here often measured using a known phase method or pulse method to determine the distance of a sensed object. This type of distance measurement is also called TOF (time of flight) or LIDAR (light detection and ranging).

To expand the measured zone, the scanning beam can be moved, as is the case in a laser scanner. A light beam generated by a laser there periodically sweeps over the monitored zone with the help of a deflection unit. In addition to the measured distance information, a conclusion is drawn on the angular location of the object from the angular position of the deflection unit and the site of an object in the monitored zone is thus detected in two-dimensional polar coordinates. The scanning movement is achieved by a rotating mirror in most laser scanners. It is, however, also known to instead have the total measurement head with light transmitters and light receivers rotate, such as is described in DE 197 57 849 B4.

The detection in said optoelectronic sensors and in a large number of further optoelectronic sensors is based on a light transmitter and a light receiver with which a transmission optics and a reception optics are associated in most cases by which the transmitted light is collimated or the remitted received light is focused and thus the range and the spatial resolution are increased. The light receiver is here designed as very small to detect as little extraneous light as possible beside its own light and to achieve a fast electronic reaction time. Typical measurements of the light sensitive area of the light receiver are in the range of some hundred micrometers.

It is accordingly necessary to position said components mechanically with respect to one another. This adjustment can relate to a plurality of degrees of freedom. The desired collimated transmitted beam is set via the distance from the light transmitter to the transmission lens. This direction is called the Z direction here. The transverse position of at least one participating component furthermore has to be adjusted such that the received light spot is incident on the light receiver as exactly as possible. Such an XY adjustment can selectively take place at the light transmitter or at the light receiver. The absolute direction in which the transmitted beam exits the sensor, that is so-to-say the line of sight of the unit or its squint angle, can be determined by an additional adjustment of a further participating component in the transverse direction.

Conventional sensors utilize different geometrical arrangements that each have their own advantages and disadvantages with respect to the adjustment demands. Biaxial and coaxial arrangements must first be distinguished here.

In a biaxial arrangement, the geometrical axis of the transmitted light is different to that of the received light. There are variants having separate transmission lenses and reception lenses and those having a dual lens as a common component here. In the case of separate lenses, the complete above-presented adjustment program is required. In addition, the light sensitive area of the light receiver is often kept larger than the dimension of the light spot, that is very small per se, would permit to have tolerances available for adhesion distortion of the fixing of the adjustment, for lateral displacements due to temperature changes or to influencing forces. More extraneous light is incident on the larger light sensitive area with the consequence of a worse signal-to-noise ratio and thereby a reduced range with the same transmission power. In addition, a larger reception element has a slower response time and therefore manages less well with high frequencies, in particular short pulses or steep flanks.

The above-explained XY adjustment could theoretically be omitted with a common dual lens. It is actually, however, mostly required, albeit to a reduced extent, since the positioning on the mounting of the light transmitter and the light receiver has tolerances in the range of a hundred micrometers and is often performed with respect to a housing element that is in turn only imprecisely positioned and has tolerances. The light sensitive area is therefore also kept larger with this model than the light spot itself would allow.

In coaxial arrangements, the geometrical axes of the transmitted light and the received light coincide. This is achieved most directly in that the light transmitter is arranged in front of the light receiver. With different models, the beam paths are merged by a deflection mirror or by a beam splitter. Different variants of the transmission and reception optics provide a central aperture of the reception lens for the passage of the transmitted light, a transmission lens arranged centrally in the reception lens, or a separate transmission lens.

The coaxial arrangements likewise require the total named adjustment program. Even a single-piece reception lens having a transmission lens at its center does not replace the XY adjustment because, as already explained, the positioning of the light transmitter and the light receiver is not accurate enough. There may even be adjustment steps in arrangements having an additional mirror. The light sensitive area is again increased for tolerance compensation.

An approach has become known from the white paper by M. Schillgalies “Micro-Hole Chip Technology For Next Level of Integrated Optical Detector Systems”, Mar. 30, 2011, having a combined electronic assembly in which the light transmitter is seated in a hole of the light receiver. However no more than vague application proposals are given; there is no practicable optical transmission/reception unit having a specific optics on this basis. At first glance, it can also not be sufficient to arrange a common transmission and reception lens in front of the electronic assembly. For the optical path in every lens is reversible. It should consequently be expected that such a common lens always images all the light emanating from the light transmitter back into the light transmitter. However, the total useful light portion of the received light would then be imaged into the hole and no detection could take place at all. In addition, a diameter is proposed for dimensions of the hole of 500 mm, which is disadvantageously larger.

EP 2 860 497 B1 discloses an optoelectronic sensor for the detection of an angle of rotation in which transmitted light is reflected at a standard, is received again, and is then evaluated. The light transmitter is seated behind a hole of the light receiver that serves as a diaphragm for beam shaping. No additional optics is provided here and would only disturb the measurement principle.

In a further optoelectronic sensor in accordance with EP 2 312 919 A1, the light transmitter is located in a coaxial arrangement on a first circuit board section in the optical path of the light receiver on a second circuit board section. A reception lens having a transmission lens at is center is supported by pins through holes of the first circuit board section on the second circuit board section and thus provides the desired spacings in the Z direction and a certain lateral orientation. However, the spacings between the light transmitter and the light receiver, for example, are still in the range of centimeters. The mechanical fixing by the reception lens provides a coarse preadjustment on this dimensional scale. A highly precise positioning is, however, only reached if this is refined by an adjustment having the above-named steps.

It is therefore the object of the invention to provide an improved transmission/reception module.

This object is satisfied by a transmission/reception module for an optoelectronic sensor and by a method of detecting objects in a monitored zone in accordance with the respective independent claim. The transmission/reception module is an optical transmission/reception assembly having a coaxial light transmitter and light receiver, and indeed in a direct coaxial arrangement without beam folding by beam splitters or the like. Coaxial means that the transmission/reception module at least outwardly behaves as a coaxial transmission/reception module; the arrangement itself is preferably already coaxial. A common optics acts as a transmission optics for at least approximately collimated transmitted light and as a reception optics for at least approximately focused received light. The angle of divergence of the light transmitter and thus the angle of irradiation of the transmitted light are here smaller than the angle of the received light.

The invention starts from the basic idea that the light transmitter and the light receiver are held from the outset in a well-defined spatial arrangement with respect to one another. They are at least indirectly micromechanically connected to one another for this purpose. The light transmitter and the light receiver can practically be considered as a single component with the precision of the mutual arrangement typical in microsystem technology. At least indirectly means that the light transmitter and the light receiver are either micromechanically connected to one another or that there is at least one intermediate part that is micromechanically connected to the light transmitter and to the light receiver, that is there is an indirect micromechanical connection of the light transmitter and the light receiver.

The invention has the advantage that no adjustment, or at best a still simple and coarse lateral or XY adjustment, is required so that the received light spot is incident on the light receiver. This adjustment step namely more precisely already takes place in the production of the electronic subassembly that at least indirectly micromechanically connects the light transmitter and the light receiver to one another. Unlike macroscopic mass production of a sensor or of an optical transmission/reception optics where a precision of 100 μm is already only successful with complex and/or expensive and error-prone methods, a positioning accuracy of 1 μm is a standard that can be achieved completely without problem in microsystem technology. Investment costs for auxiliary production means and care costs for a complex and/or expensive adjustment process that is prone to error are thus saved. Tolerances for transverse position fluctuations, for instance due to deformation on the fixing in the still remaining Z adjustment, due to temperature changes, due to acting forces and the like do not have to be available because they no longer influence the relative positioning of the light transmitter and the light receiver. The light spot can thus also be increased in size to utilize the total light sensitive area of the light receiver; and this improves the signal-to-noise ratio and the radio frequency behavior.

The common optics is preferably configured as a common lens. A particularly simple and inexpensive optics is thus used and not, for instance, an objective comprising a plurality of lenses or the like. There is also in particular no separate transmission lens present.

The light transmitter is preferably arranged at the focal point of the common lens. A sharp and small transmitted light spot is thereby produced. In many arrangements in accordance with the invention, the light transmitter and the light receiver are arranged offset from one another along the optical axis, that is in the Z direction. The light receiver is then at the same time easily displaced from the focal plane so that the received light spot is increased by defocusing. This in turn leads to the advantageous effect that a larger portion of the reflected transmission light is not again incident on the light transmitter and thus more useful light is detected.

The common lens is preferably configured as a multi-zone lens having a transmission zone and a reception zone. There is thereby the possibility of optimizing the lens properties for the transmitted light and the received light separately. The additional degrees of design freedom can be utilized to lose as little received light as possible on the light transmitter and nevertheless to maintain a small transmitted light spot to the extent these goals are compatible with one another at all.

Even more preferably, the transmission zone is arranged centrally and the reception zone is arranged surrounding the transmission zone. This is particularly well adapted to the coaxial arrangement of the light transmitter and the light receiver with a smaller angle of divergence of the light transmitter.

The transmission zone preferably has a smaller focal length than the reception lens. Even more preferably, the light transmitter is at the same time arranged in the focal plane. The larger focal length of the reception zone then produces a defocusing and thus, from a conventional viewpoint, an atypically large received light spot. This is not problematic due to the highly precise XY positioning in accordance with the invention because the larger received light spot is also reliably received without providing tolerances. The areal portion of the useful light that is lost due to the incidence on the light transmitter is thus particularly small.

The reception zone preferably has a conical component. An aberration is deliberately introduced by this that has the effect that object points are imaged on an annulus. A possible lens shape is a lens that is planoconvex starting from its base shape, but with the planar side being provided with an additional conical component in the region of the reception zone. Alternatively, the aspherical side is modified in that odd polynomial coefficients of the aspherical parameters are also used.

An annular beam profile produced by the conical component preferably has a central region of a size that corresponds to the light receiver. The size characterizes a characteristic geometrical size such as the radius or the area. The conical component is therefore adapted such that the ring produced from the received light spot surrounds the light transmitter as exactly as possible. The received light is thus practically completely deflected from the central region in which it would be lost in the light transmitter onto the light receiver. This preferably applies to received light from infinity and received light of a closer object will then no longer be able to completely avoid the light transmitter. The received light portion that is incident through the transmission zone would still have to be considered separately. This portion is, however, comparatively small due to the divergence properties of the transmitted light and the received light.

The light transmitter and the light receiver are preferably spaced apart from one another by at most 300 μm. Even more preferably, the spacing even amounts to at most 200 μm or at most 100 μm. They are orders of magnitude for microsystems that, as a reminder, would already be achieved in the sensor production simply with the typical tolerances. The spacing even more preferably relates to the Z direction. In a projection in the Z direction onto the XY direction, the light transmitter in a number of embodiments is directly next to or substantially centered in the light receiver with practically as good as no remaining spacing. In alternative embodiments, larger spacings of at most 500 μm or more are also conceivable.

The light receiver preferably has an aperture in which the light transmitter is arranged. The light transmitter then transmits the transmitted light from the light receiver, with substantially the same plane for transmission and reception. The aperture initially only relates to the light sensitive area. The light transmitter can therefore be arranged on the circuit board of the light receiver in the light sensitive area. A separate circuit board is, however, also conceivable. In this embodiment, the light transmitter and the light receiver are disposed on one plane, which facilitates the production and further processing.

The light receiver preferably has an aperture behind which the light transmitter is arranged. In this embodiment, the light transmitter transmits the transmitted light through the light transmitter so that the transmission source is set back in the Z direction with respect to the light reception. This can also initially only relate to the light sensitive area. The light transmitter then has a smaller construction height so that it disappears in the aperture, which can also be achieved by a pedestal of the light receiver. Other possibilities of an arrangement of the light transmitter behind an aperture of the light receiver provide an aperture also in the circuit board of the light receiver. An aperture of the size of the purely light emitting surface is sufficient here; the remaining light transmitter can project behind the light receiver beyond the aperture. A smaller aperture can thus be implemented than in the case in which the light transmitter is seated in the aperture.

The aperture is preferably at most 300 μm in size. Even more preferably, the aperture is even at most 200 μm or at most 100 μm in size. The size again relates to a characteristic geometrical dimension such as the diameter, the area, or an edge length. The central region of the light receiver that cannot register any received light, and thus the useful light loss, remains correspondingly small. In alternative embodiments, the aperture can, however, also be larger, that is, for example, at most 500 mm or even more. A SPAD detector can in particular easily bring along the order of magnitude of the extent of 1 mm and more required for this purpose.

On an arrangement of the light transmitter behind the aperture, a light guide element that guides the transmitted light into the aperture so that the aperture is the actual light source is preferably arranged between the light transmitter and the light receiver. Such embodiments represent an example for an only indirect micromechanical connection between the light transmitter and the light receiver with a certain spacing therebetween. The light of the light transmitter is conducted into the aperture by the light guide element so that practically all the transmitted light exits an actual, virtual light source in the aperture or in its direct proximity despite the spacing between the light transmitter and the light receiver. In this connection, the term virtual should not be confused with a virtual image of an optical image. It is rather important that the transmission/reception module behaves for all practical purposes like one in which the light transmitter is arranged in the aperture or at least very closely behind it.

A number of advantages are achieved by the greater spacing of the light transmitter from the aperture. The aperture itself can be smaller. Less reception area is therefore lost, which improves the signal-to-noise ratio and the range. In addition, light transmitters with greater dimensions can be used, for example also edge emitters. The problem of the dimensions is typically smaller with a VCSEL light transmitter that is likewise possible. Optical crosstalk is furthermore reduced and thus inter alia a better near zone detection is achieved. For transmitted light portions that would, for example, not reach the monitored zone due to flat angles of irradiation are already intercepted by the light guide element and the aperture so that they never reach the reception element.

The light guide element preferably has an optical fiber element. An optical fiber can be manufactured from solid material and can be based on total internal reflection, or it an additionally be internally mirror coated or can be configured as a hollow optical waveguide having an internal mirror coating. Alternatively, the light guide elements generates an image of the light source in or in front of the aperture. A lens, in particular a microlens, is preferably provided for this purpose. The (real) image of the light source in the aperture is the actual origin of the transmitted light viewed from the outside.

The light transmitter is preferably arranged on the light receiver. This is an alternative arrangement if the light receiver has no aperture. A small pedestal is, for example, provided on the light receiver for the light transmitter. The spacings are in turn only on a scale of microsystem technology in the range from some tens to at most some hundreds of micrometers.

A field aperture is preferably associated with the common optics. This field aperture is preferably arranged between the common lens and the light transmitter or light receiver. Lateral extraneous light that cannot be remitted useful light and only degrades the signal-to-noise ratio is screened by the field aperture. Extraneous light reductions that can easily amount to a factor of ten and more are achieved here. Apart from the improved extraneous light robustnesss and range, extraneous light generates an unnecessary power consumption and heat development in some light receivers, for example in SPADs (single photon avalanche diodes), which is likewise prevented by the field aperture. In embodiments having a light guide element, the transmitted light cannot only be guided into the aperture, but rather further through the field aperture to optimize its use even more. A real image of the light source is in particular generated in the region of the aperture opening.

The total optics, in particular its reception zone, is preferably configured to only focus the received light up to an extent of an aperture opening of the field aperture. A field aperture has the advantages just explained. With a near object, however, the field aperture can practically only allow central light to pass that is focused on the light transmitter and is lost for the detection. The transmission/reception module in accordance with the invention having a field aperture in the near zone would thus be blind. This can be counteracted by defocusing the common optics or the reception zone. The reception optical path then has a wider waist, preferably just corresponding to the aperture opening, and no sharp focus is formed on the plane of the light receiver, but rather a larger light spot of which a sufficient portion is incident on the light sensitive area and not on the light transmitter.

The common optics preferably has beam deflection properties to compensate a tilt of the reception optical path with respect to the transmission optical path. This is suitable for embodiments in which the light transmitter or the actual-light source and the light receiver itself are not arranged coaxially, but rather next to one another. The transmission/reception module then behaves coaxially toward the outside since a tilt of the reception optical path toward the transmission optical path that is caused by the arrangement next to one another and is anyway only slight is compensated by the common optics. The common optics, more precisely its reception zone, has, for example, a wedge shape or prismatic properties for this purpose so that the focusing properties have a tilt of the reception optical path superposed that compensates the tilt toward the transmission optical path.

A transmission tube is preferably arranged between the light transmitter and the common optics. Optical crosstalk is thereby prevented in the transmission/reception optics. The transmission tube admittedly simultaneously also screens the portion of the received light that is incident on the common optics in the region of the transmission tube. Such light would then, however, anyway be almost completely incident on the light transmitter and would thus not contribute to the detection.

An optical element that deflects received light incident in the direction toward the light transmitter onto the light receiver is preferably arranged in front of the light transmitter. The optical element does not cause interference on the irradiation of transmitted light due to its angle of divergence. Received light beams that would be laterally outwardly incident on the light transmitter are again deflected back outwardly and thus onto the light receiver. This is therefore a further possibility of increasing the detectable portion of the received light.

In a preferred further development, an optoelectronic sensor is provided having at least one transmission/reception module in accordance with the invention. The sensor preferably has an evaluation unit that is configured to determine a time of flight and from this a spacing from a detected object from a received signal of the light receiver. Such a time of flight measuring system or TOF system is used, for example as a laser sensor or as a laser scanner. Alternatively, however, the time of flight measurement can also be dispensed with such as in simple light sensors, light barriers, light grids, or laser scanners that only have angular resolution and no distance resolution.

A plurality of transmission/reception modules can also advantageously be used in such a sensor to form a multi-beam system. Examples for this are light grids or laser scanners having a plurality of scanning planes as an approach to a 3D sampling. A plurality of transmission/reception modules can in particular be associated with the same common optics to thus save components and production effort and/or cost.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

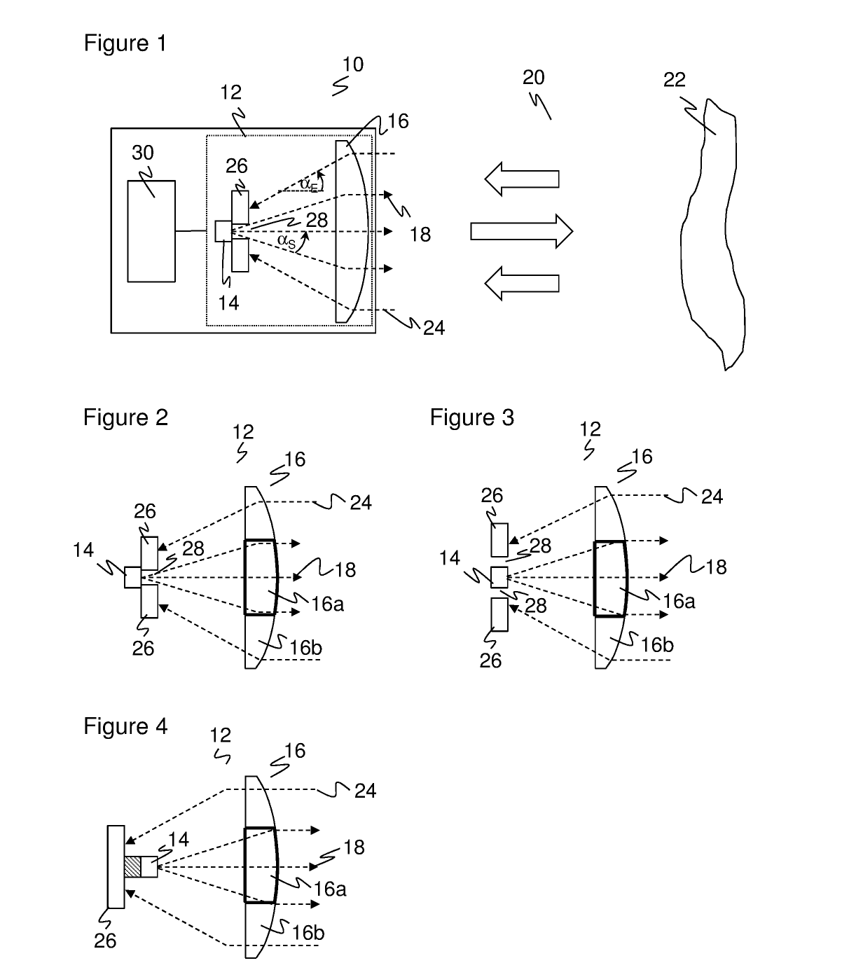

FIG. 1 a schematic sectional representation of an optoelectronic sensor having a transmission/reception module;

FIG. 2 a schematic representation of a transmission/reception module having a light transmitter behind a hole of the light receiver and having a multi-zone lens;

FIG. 3 a schematic representation similar to FIG. 2, but with the light transmitter in a hole of the light receiver;

FIG. 4 a schematic representation similar to FIG. 2, but with a light transmitter on the light transmitter;

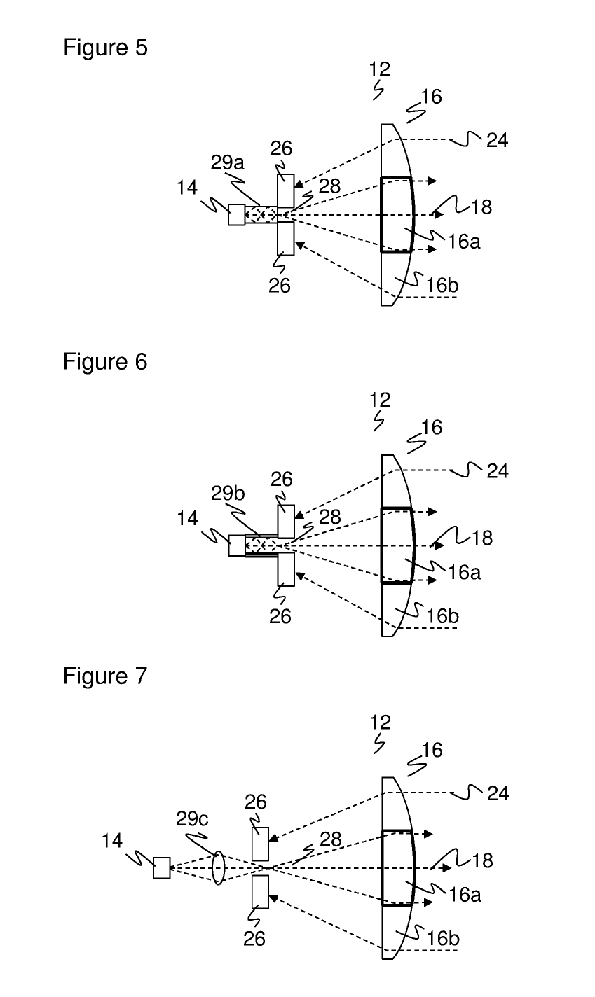

FIG. 5 a schematic representation of a transmission/reception module having a light transmitter behind a hole of the light receiver similar to FIG. 2, but having a light guide element therebetween;

FIG. 6 a schematic representation similar to FIG. 5, in which the light guide element is configured as a hollow optical waveguide;

FIG. 7 a schematic representation similar to FIG. 5 in which the light guide element generates a real image of the light transmitter;

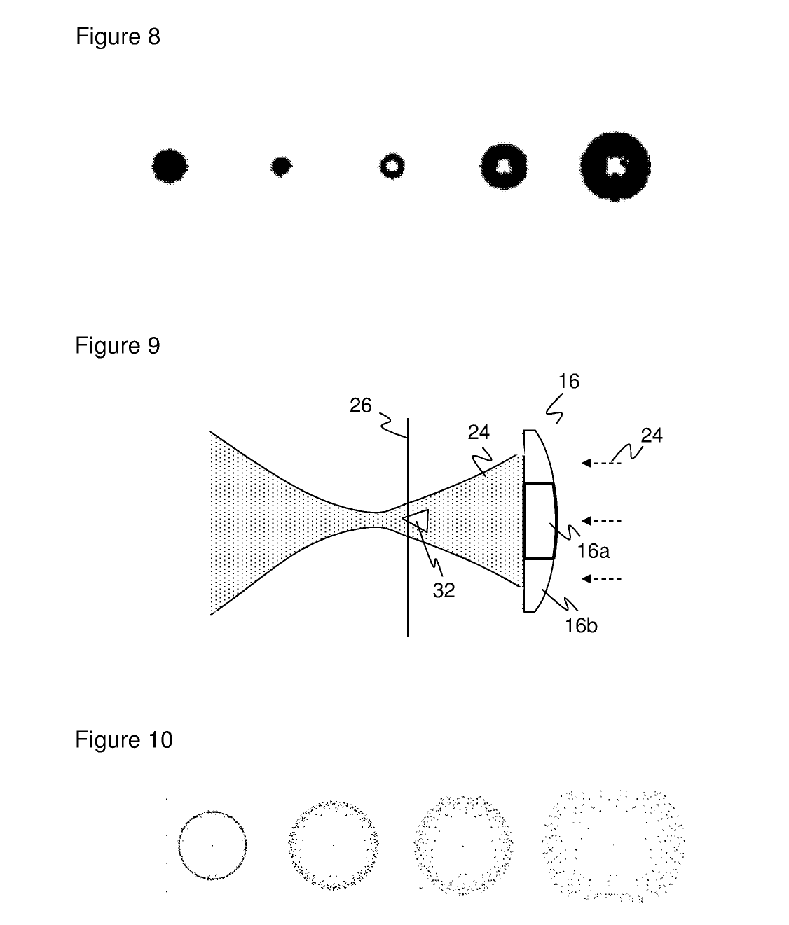

FIG. 8 spot diagrams of a light spot that a lens having a conical component produces with different defocusing;

FIG. 9 a schematic representation of the reception optical path at a lens having a conical component;

FIG. 10 spot diagrams of a light spot of a lens having a conical component at different object distances;

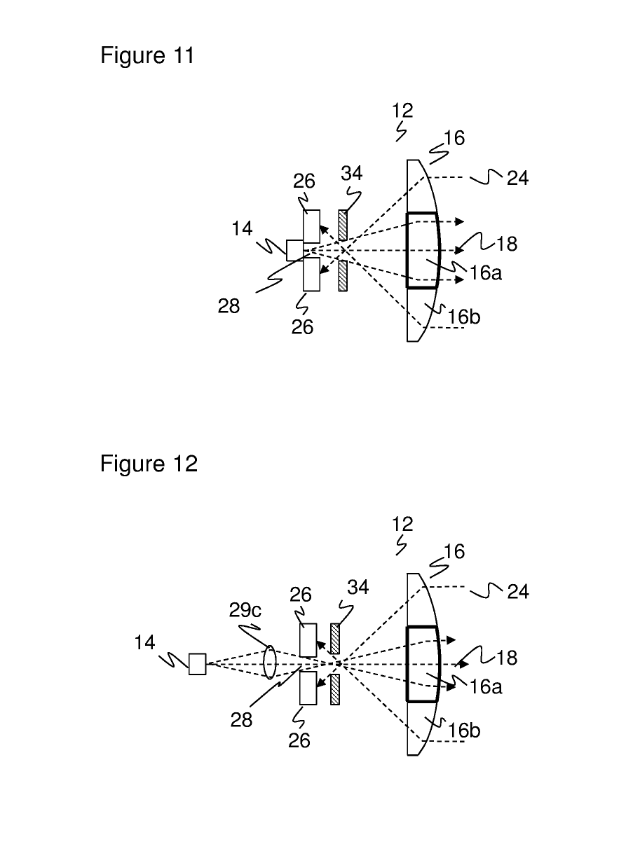

FIG. 11 a schematic representation of a transmission/reception module in accordance with FIG. 2 with an additional field aperture;

FIG. 12 a schematic representation of a transmission/reception module in accordance with FIG. 5 with an additional field aperture;

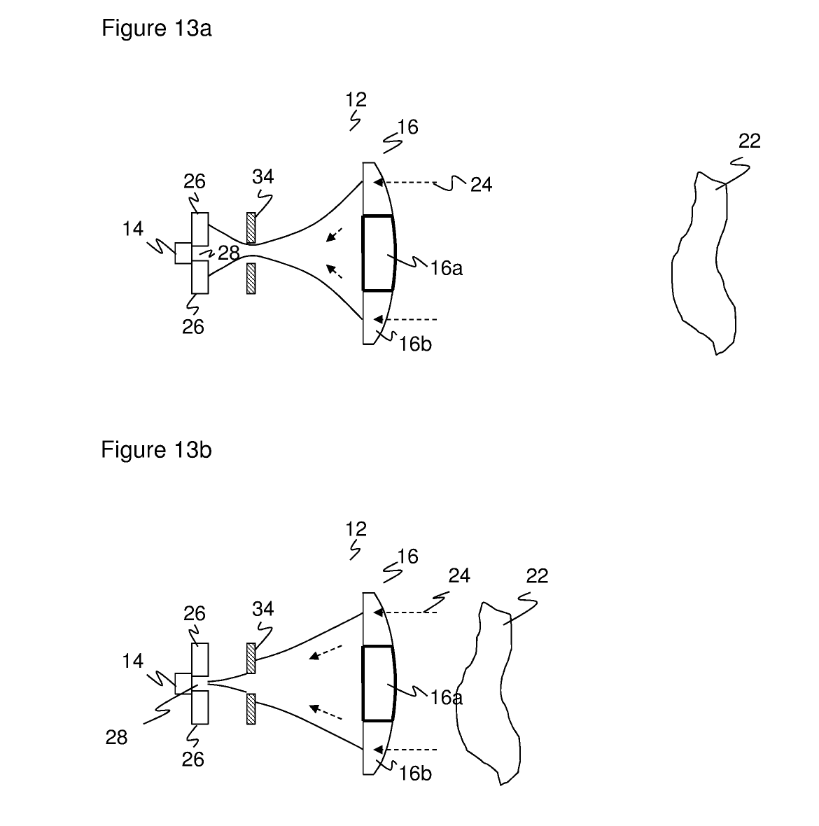

FIGS. 13a-b a schematic representation of the reception optical path of a transmission/reception module in accordance with FIG. 11 at a far object or at a near object;

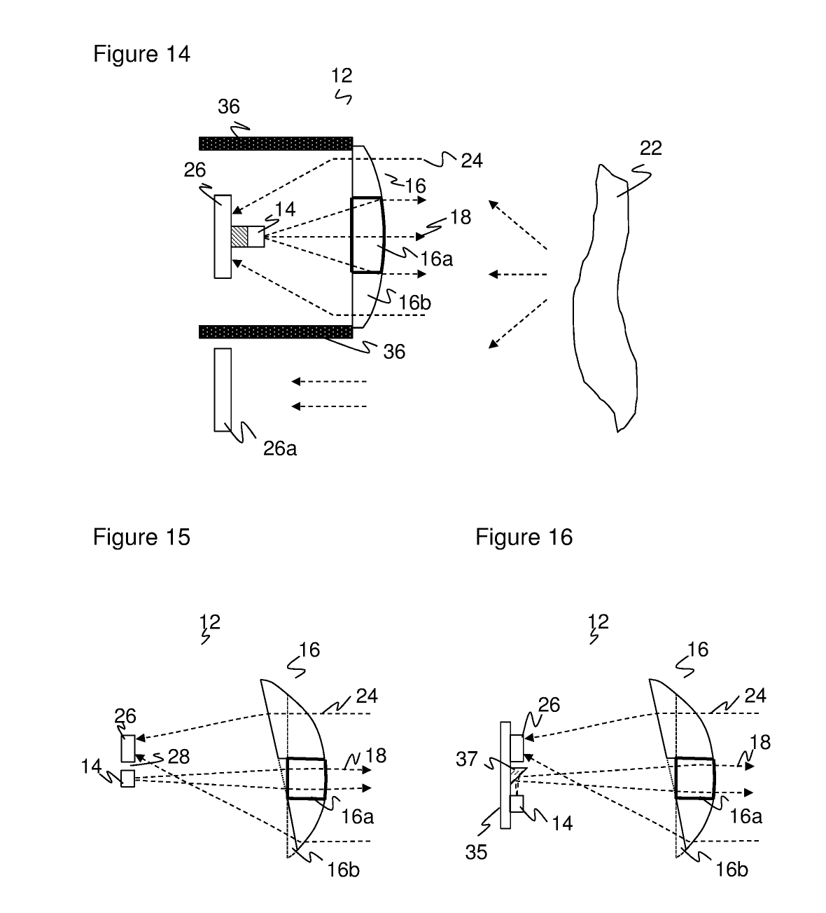

FIG. 14 a schematic representation of a transmission/reception module with an additional light receiver for the near zone;

FIG. 15 a schematic representation of a transmission/reception module with a variant of a coaxial arrangement;

FIG. 16 a schematic representation of a transmission/reception module with a variant of a coaxial arrangement in accordance with FIG. 15 with a lateral irradiation of the light transmitter;

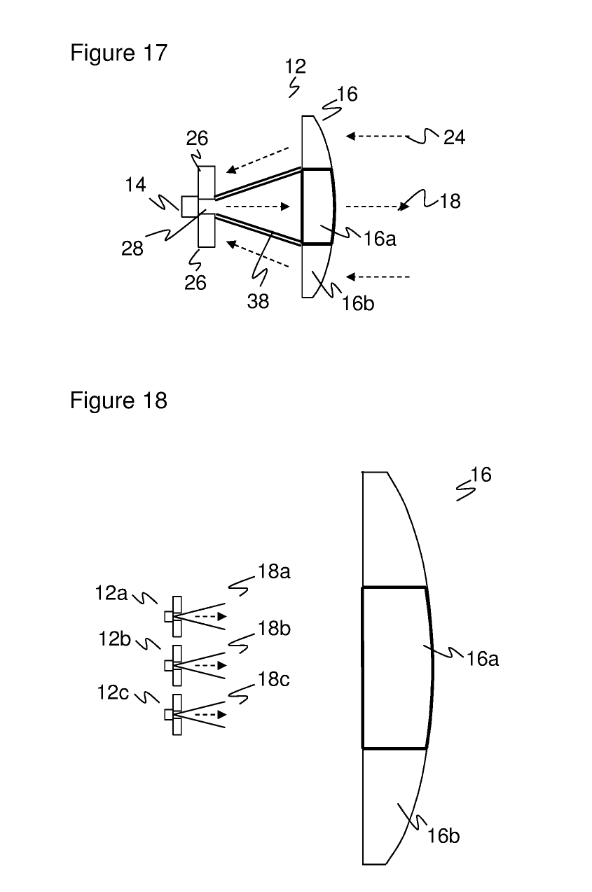

FIG. 17 a schematic representation of a transmission/reception module with a screening transmission tube;

FIG. 18 a schematic representation, not to scale, of an arrangement of a plurality of transmission/reception modules with a common lens;

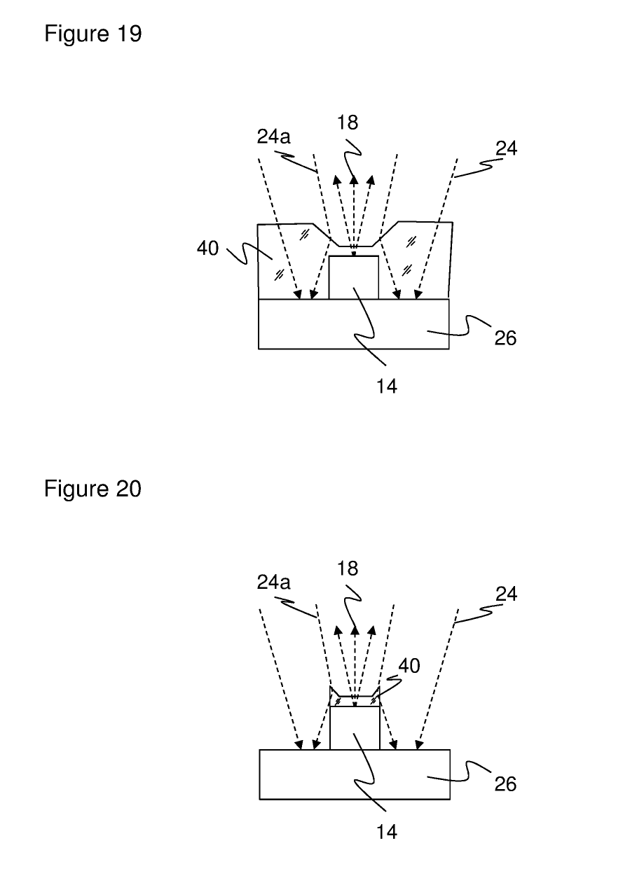

FIG. 19 a schematic representation of the optical path at a transmission/reception module with an upstream optical element for deflecting received light onto the light receiver; and

FIG. 20 a schematic representation, similar to FIG. 17, but with a changed geometry of the upstream optical element.

FIG. 1 shows a schematic sectional representation of an optoelectronic sensor 10. A light sensor is shown; however, this is only an example for explanation; other sensors are also possible such as light barriers, light grids, or laser scanners.

A transmission/reception module 12 has a light transmitter 14 that transmits a transmitted light beam 18 via a common transmission and reception optics 16 into a monitored zone 20. If the transmitted light beam 18 is there incident on an object 22, some of the light returns back to the transmission/reception module 12 as a remitted received light beam 24 and is there bundled onto a light receiver 26 by the common transmission/reception optics 16. The light receiver 26 in this embodiment has a central aperture 28 or a hole behind which the light transmitter 14 is seated and through which the transmitted light beam 18 is transmitted. This is varied in other embodiments. The light transmitter 14 and the light receiver 26 are at least in direct spatial proximity with one another and are micromechanically fastened to one another. The two-part representation of the light receiver 26 is due to the sectional view; it would be recognized in a plan view that the light receiver 26 is contiguous and has the central aperture 28. Embodiments are, however, also conceivable in which the light receiver 26 is not contiguous. Two or more separated light sensitive areas then surround the aperture 28 that can, but do not have to, almost contact one another at least at corners or edges. The arrangement of the transmission/reception module 12 is coaxial; the light transmitter 14 and the light receiver 26 are therefore disposed on the same optical axis. The irradiation path is not folded; there are in particular no beam splitters or deflection mirrors that establish the coaxial arrangement at all, with a common deflection mirror that relates both to the transmission path and to the reception path generally remaining conceivable, for example to optimize the construction space or the installation.

The light transmitter 14 can be configured as an LED or as a laser, in particular as a VCSEL laser or as an edge emitting laser diode. The light receiver 26 is, for example, a PIN diode, an APD (avalanche photo diode), or a single photon APD (SPAD), or a multiple arrangement. An advantage of a SPAD beside its exceptionally high sensitivity is also the possibility of quickly switching it to sensitive or non-sensitive (“active quenching”, time gating, time windows, adaptation of the bias voltage). Interference portions that arise due to optical or electrical crosstalk can thereby be very effectively masked in that the sensitive time windows are set such that the crosstalk signal has already dropped, but the measurement signal has not yet returned, not even from near distances. In addition, SPAD arrangements can easily be used in a construction size of 1 mm and more, which provides advantages in some of the embodiments still to be explained for large received light spots.

An evaluation unit 30 controls the light transmitter 14 and evaluates the received signal of the light receiver 26 to detect the object 22. The evaluation can, for example, include a time of flight method to measure the distance from the object 22; for instance, a single pulse method, multi-pulse method, or phase method known per se. The evaluation unit 30 is also representative for further possible electronic components of the sensor 10 that will not be looked at in any more detail.

The common optics 16 is illustrated as a common lens in FIG. 1. This means that it is a preferably single-piece common element without any mechanical separation that is responsible both for the transmitted light beam 18 and for the received light beam 24. The common lens is, for example, manufactured from plastic or from glass. A glass lens is particularly advantageous for industrial applications because a sufficiently small temperature range can thus be achieved for the transmitted light beam 18.

The angle of divergence αₛ of the light transmitter 14 and thus of the transmitted light beam 18 is smaller than the angle α_{E} of the received light bundle 24. This has the result that sufficient received light is incident on the light receiver 26 even though a portion thereof is lost in the aperture and thus on the light transmitter 14 or, in other embodiments, also by a shading of the light transmitter 14. This can be easily understood using the schematic beam progressions and the two angles αₛ, α_{E} in FIG. 1.

In addition, a numerical example should be given at this point. A common lens is assumed as the reception optics 16 by way of example for this. Unlike many examples following below, this lens has unchanging properties at the center, where the transmitted light beam exits as outside, for instance a focal length that is the same everywhere. The lens is designed as a plano-asphere from glass having a center thickness of 13 mm, a refractive index of n=1.515, a focal length of f=30 mm, and a useful aperture of 35 mm, wherein the radius r, the cone k, and the two straight polynomial coefficients a₄ and a₆ of the asphere parameters being used. The irradiation angle αₛ of the light transmitter 14 amounts to ±15° and the maximum angle α_{E} of the received light beam 24 amounts to ±38°. The light transmitter 14 is arranged at the focal point of the lens. The aperture 28 in the light receiver 26 has a diameter of 130 μm, with a mechanical thickness of the chip of the light receiver 26 of 150 μm that also determines the depth of the aperture 28. The light transmitter 14 has dimensions of 300 μm, with 50 μm thereof comprising the light emitting area. The required hole diameter also results from this in another respect: 50 μm+2*tan(15°*150 μm=130 μm. The resulting size of the received light spot on the light receiver 25 is then 2*tan(38°*150 μm=235 μm. Consequently, a portion of approximately (235²−130²)/235²=70% of the received light beam 24 is not incident on the aperture 28 and is detected. The spot size can be further increased and an even greater reception efficiency of more than 70% can be achieved by as light defocusing of the transmitted light beam 18.

FIG. 2 shows a further embodiment of a transmission/reception module 12. The design largely corresponds to FIG. 1. However, the common optics 16 is now no longer configured as a uniform lens having the same properties everywhere. The lens as a multi-zone lens now rather has a transmission zone 16a as a central lens part for the transmitted light beam 18 and a surrounding reception zone 16b as an outer lens part for the received light beam 24. The multi-zone lens is also preferably a single, one-piece lens in which, however, different optical properties are implemented in dependence on the zone, with the zones preferably being arranged coaxially. It must be mentioned as a precaution that some of the received light bundle 24 can naturally also be centrally incident on the transmission zone 16a. This portion, however, substantially differs in the aperture 28 or on the light transmitter 14 and is thus lost for the detection and therefore remains out of consideration at many points in this description.

The lens effect can therefore be set differently for the transmitted light bundle 18 and the received light bundle 24 due to the multi-zone lens. The focal length of the transmission zone 16a can in particular be selected as not the same as the focal length of the reception zone 16b. The selection of a smaller focal length in the transmission zone 16a is advantageous to increase the received light spot of the received light bundle 24 on the light receiver 26. The relative portion of the received light beam 24 that is lost in the aperture 28 or on the light transmitter 14 thereby becomes smaller. Due to the same consideration, the light receiver 26 should not be seated in the focus of the reception zone 16b to achieve the atypically large received light spot. Such a defocus and thus an increase in the received light spot would not be considered in a conventional observation. A sharp imaging with a small received light spot and surrounding free marginal regions on the reception surface of the light receiver 26 is rather aimed for there to maintain tolerances. In accordance with the invention, such tolerances are not required because the XY adjustment from the light transmitter 14 to the light receiver 26 with extremely high accuracy has already been reached in advance.

FIG. 3 shows a further embodiment of the transmission/reception module 12. Unlike FIG. 2, the light transmitter 14 here is not arranged behind the aperture 28, but in it. Both have advantages and disadvantages. In the arrangement in accordance with FIG. 2, the aperture 28 can remain relatively small because only the light emitting area of the light transmitter 14 has to irradiate through the aperture 28. In the above numerical example with respect to FIG. 1, this was 50 μm in comparison to a total dimension of the light transmitter 14 of 300 μm for which connection regions for the electronic contacting are also required in addition to the light emitting area. In addition, the aperture 28 acts as a diaphragm for bounding the irradiation angle αₛ. In the arrangement in accordance with FIG. 3, the aperture 28 accordingly has to be large enough to receive the total light transmitter 14. All the elements are in one plane for this, which simplifies the chip design and the chip production.

FIG. 4 shows a further embodiment of the transmission/reception module 12 that manages without an aperture 28. The light transmitter 14 is instead centrally arranged on the light receiver 26. This can simplify the common production of a chip for the light transmitter 14 and the light receiver 26 because no aperture 28 is required. However, the light transmitter 14 shades a comparatively large portion of the received light beam 24 and also itself takes up space for its contacting. Larger received light spots are therefore more required that can only just be implemented, for instance, with an APD having dimensions of 500 μm. It can therefore be advantageous to use a larger light receiver 26, for example a SPAD detector having dimensions in an order of magnitude of 1 mm.

In the embodiments in accordance with FIGS. 2 and 3 with a light transmitter 14 in the aperture 28, disadvantages can result, specifically with respect to the required diameter of the aperture 28. It would be optically ideal if the aperture 28 were to correspond exactly to the diameter of the beam bundle of the transmitted light 18. A larger aperture 28 is, however, actually required for various reasons. This, on the one hand, with an arrangement of the light transmitter 14 in the aperture 28, as in FIG. 3, for obvious reasons relates to the dimensioning of the light transmitter 14 whose optically active area is smaller than the total extent. However, even with an arrangement of the light transmitter 14 behind the aperture 28, there are still electrical conductor tracks or further semiconductor material that should not directly contact the light receiver 26. A further example is given by edge emitters as the light transmitter 14. The lateral light exit requires a tilted arrangement with respect to the surface of the light receiver 26 so that the light transmitter 14 and the light receiver 26 cannot be arranged directly on one another as in FIG. 2.

Currents or electromagnetic fields from the light receiver 14 can continue to pass into the light receiver 26 in direct spatial proximity of the light transmitter 14 and the light receiver 26, possibly even with a contact. Such an electrical crosstalk results in falsified received signals and in particular occurs at high frequencies in an order of magnitude of 1 GHz and more, that are, however, actually by all means desired in time of flight measurements.

A further aspect is the optical crosstalk. Some transmitted light is irradiated by the light transmitter 14 so that it cannot be used because it is, for example, irradiated at a large angle of divergence. This light portion practically does not disadvantageously impair the transmission power, but the light can rather enter into the light receiver 26 and can there falsify the actual received signal. An arrangement as in FIG. 2 can promote the crosstalk, for instance over the inner surface of the aperture 28.

FIGS. 5 to 7 show embodiments having an additional light guide element 29a-c and a certain spacing between the light transmitter 14 and the light receiver 26 by which said problems can be eliminated or at least alleviated. These embodiments are based on the common idea of physically removing the light transmitter 14 from the light receiver 26. Effectively, however, the aperture 28 remains the starting point of the transmitted light 18 or the actual light source because the transmitted light 18 is conducted from the light transmitter 14 by means of the light guide element 29a-c into the aperture 28. The light transmitter 14 and the light receiver 26 are furthermore indirectly micromechanically connected via intermediate components so that the adjustment advantages are maintained.

FIGS. 5 to 7 show three examples for the specific choice of the light guide elements 29a-c by which an actual or virtual light source is generated in direct proximity to the light receiver. In FIG. 5, the light guide element 29a is an optical fiber that is produced as a volume element from light permeable material such as glass or plastic and that conducts the transmitted light 18 by total reflection. In FIG. 6, the light guide element 29b is a hollow body that is internally mirror coated. A volume element can alternatively also have a mirror coating.

In FIG. 7, the light guide element 29c is configured as an imaging element; in this case, a converging lens, preferably a microlens. A real image of the light transmitter 14 or of its light emitting surface is thereby generated in the aperture 28. The image can also be arranged just in front of or behind the aperture 28 instead of the location in FIG. 7.

FIGS. 8 to 11 illustrate an advantageous further development of the lens that serves as a common optics 16 having an additional conical component. The conical component preferably only relates to the reception zone 16b. With a plano-asphere, the planar side can have a conical shape, that is it can be configured as an axicon. Another possibility is to configure the asphere side as a so-called “odd asphere”. In the polynomial representation of the sagittal height, it is no longer only the even powers of the radius that are represented there, but also odd powers. The polynomial coefficient a₁ is most simply used for this purpose that has a sagittal height proportional to a₁*Spacing from the lens center, that is the desired conical shape. Different odd polynomial coefficients can, however, also be used to correspondingly modify the lens contour.

The asphere formula is additionally shown in the following in this respect:

$$z ( r ) = \frac{ρ {r}^{2}}{1 + \sqrt{1 - ( 1 + k ) {( ρ r )}^{2}}} + {\sum }_{i = 2}^{n} {a}_{2 i} {r}^{2 i} + {\sum }_{i = 1}^{m} {a}_{2 i + 1} {\vert r \vert}^{2 i + 1} ,$$

where: z is the sagittal height; r is the spacing perpendicular to the axis or to the height of incidence; p is the vertex curvature (vertex radius R=1/ρ9; k is the conical constant; a₂ᵢ a₂ᵢ₊₁ are even or odd coefficients of the correction polynomial; max(2n, 2m+1) is the degree of the polynomial.

It is achieved by introducing a conical component, whether on the plano side, via odd polynomial coefficients, or quite a different lens shape that an object point is no longer imaged on an image point on the light receiver 26, but rather on a small annulus. The lens having the conical component therefore generates an annular beam profile whose contour depends on the focal location.

This is illustrated for spot profiles in different focal locations in FIG. 8. The center spot profile corresponds to an arrangement at the focus, where a sharp annulus arises in idealized form. If the reception plane is moved closer to the lens, to the right in FIG. 8, a “donut” or torus having a kind of light hole at the center is produced. In the counter-direction, the light spot closes and increases in size as the distance from the focal location increases. The relationships can be horizontally mirrored by changing the sign of the polynomial coefficient a₁; there is therefore thereby an elective possibility as to on which side of the sharp focal location a respective torus having a light hole or a closed light spot is formed.

FIG. 9 illustrates the optical path again in a sectional view. An annular beam profile having a light hole 32 that only faces one direction of the sharp focal location is produced by the conical component of the lens of the common optics 16. The drawn reception plane of the light receiver 26 corresponds to the sharp annulus at the center of FIG. 8. The association with the spot profiles of FIG. 8 on a movement of the reception plane to the right or to the left likewise becomes directly understandable. As already explained, the light hole 32 in FIG. 9 can be so-to-say mirrored at the drawn reception plane by a sign change of a₁.

The arrangement in accordance with FIG. 9 with the light receiver 26 in the plane of the sharp annulus is particularly preferred because then all the light of the received light bundle 24 is just incident outside the aperture 28 or, depending on the embodiment, outside the shadow of the light transmitter 14. The conical component should be simultaneously configured for this purpose such that the generated annulus has a diameter by which it surrounds the aperture 28. For the simplest case that the conical shape is generated via a₁, the circle diameter can be coarsely estimated at 2f_{E}|a₁|(n−1), where f_{E} is the nominal focal length of the reception plane 16b and n is the refractive index of the lens.

Let the value −0.005 be selected for a₁ as a specific numerical example. It must again be mentioned that this only relates to the reception plane 16b; the odd polynomial coefficients preferably remain at the value 0 in the transmission zone 16a. Let the other dimensions and parameter including the other asphere parameters be the same as in the above numerical example with respect to FIG. 1 with a focal length f_{E} of 30 mm and a refractive index n of the lens of 1.5. An annulus then results from the estimate of the previous paragraph having a diameter of approximately 2*30 mm*0.005*(1.5−1)=150 μm. The aperture 28 of 130 μm in FIG. 2 can thus be surrounded.

In an alternative numerical example, the value +0.01 is selected with otherwise the same values for a₁. The circle diameter then becomes 2*30 mm*0.01*(1.5−1)=300 μm. This is just sufficient to surround the larger aperture 28 in FIG. 3 or the shadow of the light transmitter 14 in FIG. 14 with dimensions of 300 μm in each case; a somewhat larger a₁ can be selected as required.

In these numerical examples, provision is made by the sign of a₁ that not only objects 22 at infinity, but also objects 22 coming closer generate a light spot that is still incident on the light sensitive surface of the light receiver 26 and does not completely disappear in the aperture 28 or on the light transmitter 14. With an incorrect arrangement or sign selection, this could namely easily occur, with the consequence of a dead zone of several meters in size in the proximity of the transmission/reception module 12.

FIG. 10 shows spot diagrams at different object distances for the case of a sensible selection of a₁, as explained. The object distances shown are here, from left to right, infinity, 8 m, 4 m and 2 m. It can easily be recognized that the received light spot on the light receiver 26 admittedly does not remain a sharp annulus for an object 22 at infinity, but rather as good as no light continues to move into the center and the light receiver 26 continues to receive received light spots of closer objects 22 increased in size by blur.

FIG. 11 shows a further embodiment of the transmission/reception module 12 having an additional field aperture 34. The reception optical path of the received light bundle 24 has an intermediate focus that is disposed in the proximity of the diaphragm position. An effect as a field aperture 34 therefore arises that greatly reduces the field of vision of the light receiver 26 and thus masks extraneous light that cannot emanate from the light transmitter 14 or its transmitted light beam 18. The result is a considerable improvement of the signal-to-noise ratio.

There is a conflict between two opposite interests here: To thread as much transmitted light 18 as possible through the field aperture 34, a large diaphragm aperture at great proximity is desirable. On the other hand, a small diaphragm having a certain spacing from the receiver is required for an effective reduction of the reception FOV. A compromise therefore has to be found here.

FIG. 12 illustrates that this conflict can be resolved in a preferred embodiment similar to FIGS. 7 to 9 by a light transmitter 14 offset a little toward the light receiver 26 by a light guide element 29a-c. FIG. 12 is practically a combination of the embodiment in accordance with FIG. 9 with an imaging light guide element 29c and a field aperture 34 in accordance with FIG. 11. It is possible here to push the image of the light transmitter 14 so far in front of the aperture 28 in the proximity of the field aperture 34 or even into its plane that practically all the transmitted light 18 also passes through an extremely narrow field aperture 34. The demand at the transmission side for a large aperture is dispensed with because the transmitted light 18 can be focused at the location of the field aperture 34.

Embodiments having optical fibers as the light guide elements 29a-b in accordance with FIG. 7 or FIG. 9 can also be combined in a similar manner with a field aperture 34. It is, however, not possible here to transpose the exit point of the transmitted light 18 up to and into the field aperture opening because then the light guide element 29a-b would be in the way of the received light 24. However, the exit point can very easily be displaced a little into the region between the light receiver 26 and the field aperture 34.

FIGS. 13a-b illustrate a general problem of such a design with an intermediate focus for the received light beam 24. The reception optical path is shown for a far object 22 in FIG. 13a and for a near object in FIG. 13b. The reception focus is displaced away from the lens of the common optics 16 for objects coming closer and thus moves closer to the light receiver 26. The received light beam 24 is then focused so tightly on the aperture 28 at a certain proximity of the object 22 that practically the total light disappears there and objects 22 can no longer be detected. Such a dead zone can already form for distances below two to three meters.

This near zone problem can, however, also be solved by optimizations of the lens. The lens, in particular its reception zone 16b, is designed such that the minimal beam waist, so-to-say at the reception focus, no longer becomes very small, but rather intentionally only reaches a certain minimal diameter that just passes through the field aperture 34. The received light spot is therefore also no longer smaller than the aperture opening of the field aperture 34 with near objects so that sufficient light of the received light beam 24 remains on its suitable configuration that does not disappear in the aperture 28.

There are various possibilities of achieving this effect in the lens design. For example, aberrations are deliberately maintained that result in such a large received light spot. Alternatively, an asphere of the parameters a₁ is used via which the minimal beam diameter in the focus can be set. The cross-section of the received light beam 24 then nowhere becomes smaller. The advantages of an annulus explained with respect to FIGS. 8 to 10 are combined with those of a field aperture 34 by this procedure.

Some numerical examples that are optimized for large object distances without restrictions thus implied should also be given for embodiments having a field aperture 34. In this respect, let in each case in large agreement with the previous examples, the irradiation angle at the transmission side be αₛ=±15°, the maximum angle at the reception side be α_{E}=±30°, the chip thicknesses be 150 μm, the light emitting area be 50 μm, at a chip size of 300 μm of the light transmitter 14. Dimensions of 1 mm are used for the light transmitter 26, with this not playing any role for the calculations, but rather only sufficient space being available to receive the received light spot, with the aperture opening of the field aperture 34 in particular being smaller than the light receiver 26. The estimates of the reception spot sizes and as a consequence of the reception efficiencies start from the slightly simplifying assumption that the field aperture 34 is exactly positioned in the intermediate focus of the reception optical path.

In a first example for the situation of FIG. 2 with the light transmitter 14 behind the aperture 28 with a diameter of 130 μm, a field aperture 34 having a hole diameter of 280 μm is arranged at a spacing of 260 μm from the light receiver 26. The received light spot on the light receiver 26 then has a diameter of approximately 300 μm from which a reception efficiency of approximately 80% results.

In a second example for the situation of FIG. 3 with the light transmitter 14 in the aperture 28 with a diameter of 300 μm, a field aperture 34 having a hole diameter of 300 μm is arranged at a spacing of 480 μm from the light receiver 26. The received light spot on the light receiver 26 then has a diameter of approximately 550 μm from which a reception efficiency of approximately 70% results.

In a third example for the situation of FIG. 4 with a light transmitter 14 positioned directly in front of the light receiver 26, the former generates a shadow having a diameter of 480 μm. A field aperture 34 having a pin diameter of 340 μm is arranged at a spacing of 690 μm from the light receiver 26. The received light spot on the light receiver 26 then has a diameter of approximately 800 μm from which a reception efficiency of approximately 65% results.

FIG. 14 shows a schematic representation of a further embodiment of a transmission/reception module 12. This transmission/reception module 12 is based on an arrangement of the light transmitter 14 in front of the light receiver 26 in accordance with FIG. 4, but could equally set on other embodiments, in particular with an aperture 28, for example in accordance with FIG. 2 or 3.

A problem can result with optical crosstalk or also electrical crosstalk from the transmission path directly into the reception path by the direct spatial proximity in accordance with the invention of the light transmitter 14 and the light receiver 26. With a pulsed system, the active phase of the light transmitter 14 and thus the crosstalk is short, above all when a short pulse length of at most 1 ns is selected, for example. In the near zone, while the light transmitter 14 still generates the pulse, the detection of the light receiver 26 is, however, still disturbed, up to a practically complete loss of the detection ability.

To solve this, an additional light receiver 26a is provided for the near zone in the embodiment in accordance with FIG. 14. This additional light receiver 26a is preferably arranged outside an optical, optionally also electrical, screen 36 that suppresses crosstalk. An object 22 in the near zone, for example at a spacing up to 500 mm, remits the transmitted light beam 18 from the view of the transmission/reception module 12 in a very large range so that the additional light receiver 26a receives sufficient light, and indeed even without a separate reception optics. It is, however, conceivable to complement an additional reception lens that can also be connected as a dual lens to the common reception optics 16, but then preferably with a screen integrated therein in the transition region. The additional light receiver 26a is preferably likewise connected to the evaluation unit 30, but can alternatively also be controlled and evaluated by its own electronics.

Another conceivable measure to prevent crosstalk or at least to limit its effects, is the already addresses gating or instead of the additional light receiver 26a, another complementary sensor is used for the near zone, for instance an inductive, capacitive or magnetic ultrasound sensor or radar sensor. A complete optoelectronic additional module having a design in accordance with the invention or having a conventional design or even a separate additional optoelectronic sensor are also conceivable.

FIG. 15 shows a schematic representation of a transmission/reception module 12 with a variant of a coaxial arrangement. In strict terms with a coaxial arrangement, the light transmitter 14 and the light receiver 26 have to lie on one axis continuously or at least after the combination of the beam paths. This strict term interpretation is preferably required everywhere for the embodiments in accordance with the invention. First, however, a somewhat broader definition is also permitted that will be explained for FIG. 15 and that could still be called coaxial because the beam paths outside the transmission/reception module 12 correspond to a coaxial system and not to a biaxial system for all practical purposes.

The light transmitter 14 and the light receiver 26 are next to one another in FIG. 15. The aperture 28 is only bounded at one side. The light transmitter 14 and the light receiver 26 are, however, still directly next to one another, at the spacings already mentioned multiple times, of at most 300 μm or even less; in some cases, such as with a SPAD detector, also somewhat further at at most 500 μm or sometimes even more. The light transmitter 14 and the light receiver are at least micromechanically fastened to one another and can thereby be positioned very accurately.

The lens of the common optics 16 is still coaxial in the sense that the transmission zone 16a is seated centrally, surrounded by the reception zone 16b; however, possibly displaced minimally from the center. Such a displacement has hardly any practical effect in view of the micrometer spacings between the light transmitter 14 and the light receiver 26 in comparison with the spacing from the lens.

The shape of the lens, however, preferably differs. It is no longer rotationally symmetrical in the region of the received zone 16b but has a wedge shape or prismatic properties there. Such modifications can be applied to the planar side or they are integrated in the curved side that was already explained above for an additionally conceivable conical component. The tilt is shown in greatly exaggerated form in FIG. 15; a magnitude of 20 mrad or of 1′° is actually sufficient, which would approximately be the value for a lateral offset of 500 μm between the light transmitter 14 and the light receiver 26 with a focal length of 50 μm and a refractive index of 1.5.

With such an arrangement and such a lens, the beam progression outside the transmission/reception module 12 is then both concentric and colinear because the slight tilt of the reception optical path to the transmission optical path within the transmission/reception module 12 is compensated by the wedge shape of the reception zone 16b; it is thus effectively coaxial, albeit not in the strict above-named understanding of the term because the light transmitter 14 and the light receiver 26 are next to one another.

FIG. 16 shows how the just described common optics 16 having tilt properties of the reception zone 16b can be used for a light transmitter 14 having a lateral light exit, in particular an edge emitter. For this purpose, the light transmitter 14 and the light receiver are arranged at the same plane next to one another and are micromechanically connected to one another, here by way of example by arrangement on a common micromechanical carrier plate 35. The laterally exiting transmitted light 14 first extends in parallel with the plane of the carrier plate 35 and is then deflected in the desired irradiation direction by a deflection element 37. The optical path is then effectively the same as in FIG. 15.

FIG. 17 illustrates a further embodiment of the transmission/reception module 12. The transmission optical path is here screened by a transmission tube 38. Any shapes of a mechanical channel separation are meant by this with which optical crosstalk and possibly also electrical crosstalk is prevented. The transmission tube 38 naturally also prevents centrally incident portions of the received light beam 24 from being able to reach the light receiver 26. Such portions are, however, anyway practically not present due to the reversibility of the radiation paths in the transmission zone 16a.

FIG. 18 shows a further embodiment in which a plurality of transmission/reception modules 12a-c are positioned behind a common optics 16. As long as the lateral spacing between the transmission/reception modules 12 is much smaller than the total dimension of the lens, it is still possible to design a single lens with a central transmission zone 16a for the plurality of transmitted light beams 18a-c and with an outer reception zone 16b for the plurality of received light beams 24. It is to be considered in this respect that the representation in FIG. 18 is not to scale. A very simple and compact multi-beam module is produced by the combination of a plurality of transmission/reception modules 12a-c and can be used, for example, in a light grid, in a multi-sensor, or in a laser scanner having a plurality of scan planes. A plurality of multi-beam modules can naturally be combined with one another to obtain even more beams.

FIGS. 19 and 20 illustrate yet a further embodiment of the transmission/reception module 12 that is particularly, but not exclusively, suitable for the arrangement of a light transmitter 14 on the light receiver 26 in accordance with FIG. 4. An additional optical element 40 is here arranged in front of the light receiver 26 and the light receiver 14; in FIG. 20, due to a different geometrical design, only in front of the light transmitter 14. The optical element 40 is shaped so that the exiting transmitted light beam 18 is practically not influenced due to the small entry and exit angles. Some beams 24a of the transmitted light beam 24 that would converge toward the light receiver 14 and would thus be lost for the detection, are, however, broken up toward the outside due to their more oblique angle of incidence and the rising geometry of the optical element in a perimeter around the center and are therefore at least in part still incident on the light receiver 26. The optical element 40 thus acts as a kind of cloak of invisibility that makes the light transmitter 14 invisible for the beams 24a in that they are deflected to the light receiver 26. The amount of the light lost by the light transmitter 14 and its shadow is thereby reduced. The optical element 40 can be implemented, for example, as a casting on the light transmitter 14 or on the light receiver 26.

The invention was described with reference to embodiments that are primarily directed to a specific advantageous modification, but sometimes also in specific combinations. The invention also comprises the variants with which the advantageous modifications are combined in a different manner. The arrangement of the light transmitter 14 behind the aperture 28, in the aperture 28, or in front of the light receiver 26 or the design of the lens with a plurality of zones, with a conical component and/or with aberrations can thus be selected largely independently of one another; the field aperture 34 can be added or omitted in various spacings and sizes of the diaphragm aperture; and an additional light receiver 26a, or an arrangement slightly differing from the ideal coaxial arrangement and with a correspondingly adapted reception optics 16, the transmission tube 38 and/or the optical element 40 can be added or omitted. In addition, transmission/reception modules 12a-c that are of the same type or also different in various embodiments can be combined as in FIG. 18 to a multi-beam module.

1. A transmission/reception module for an optoelectronic sensor, the transmission/reception module comprising:
a light transmitter having a transmission optics and
a light receiver having a reception optics, wherein an irradiation angle of transmitted light of the light transmitter is smaller than a reception angle of received light incident on the light receiver; the light transmitter and the light receiver are arranged coaxially; the transmission optics and the reception optics are formed as a common optics; and the light transmitter and the light receiver are micromechanically connected to one another.

2. The transmission/reception module in accordance with claim 1,
wherein the common optics is configured as a common lens.

3. The transmission/reception module in accordance with claim 2,
wherein the light transmitter is arranged at the focal point of the common lens.

4. The transmission/reception module in accordance with claim 2,
wherein the common lens is configured as a multi-zone lens having a transmission zone and a reception zone.

5. The transmission/reception module in accordance with claim 4,
wherein the transmission zone is arranged centrally and with the reception zone being arranged surrounding the transmission zone.

6. The transmission/reception module in accordance with claim 4,
wherein the transmission zone has a smaller focal length than the reception zone.

7. The transmission/reception module in accordance with claim 4,
wherein the reception zone has a conical component.

8. The transmission/reception module in accordance with claim 7,
wherein an annular beam profile generated by the conical component has a size that corresponds to the light receiver.

9. The transmission/reception module in accordance with claim 1,
wherein the light transmitter and the light receiver are spaced apart from one another by at most 300 μm.

10. The transmission/reception module in accordance with claim 1,
wherein the light receiver has an aperture in which or behind which the light transmitter is arranged.

11. The transmission/reception module in accordance with claim 10,
wherein the aperture is at most 300 μm in size.

12. The transmission/reception module in accordance with claim 10,
wherein the light transmitter is arranged behind the aperture and a light guide element is arranged between the light transmitter and the light receiver and guides the transmitted light into the aperture such that the aperture is the actual light source.

13. The transmission/reception module in accordance with claim 10,
wherein the light guide element has an optical fiber element or generates an image of the light source in or in front of the aperture.

14. The transmission/reception module in accordance with claim 1,
wherein the light transmitter is arranged on the light receiver.

15. The transmission/reception module in accordance with claim 1,
wherein a field aperture is associated with the common optics.

16. The transmission/reception module in accordance with claim 15,
wherein the common optics is configured to focus the received light only up to an extent of a diaphragm aperture of the field aperture.

17. The transmission/reception module in accordance with claim 1,
wherein the common optics has beam deflection properties to compensate a tilt of the reception optical path toward the transmission optical path.

18. The transmission/reception module in accordance with claim 1,
wherein a transmission tube is arranged between the light transmitter and the common optics.

19. The transmission/reception module in accordance with claim 1,
wherein an optical element is arranged in front of the light transmitter and deflects received light incident in the direction onto the light transmitter to the light receiver.

20. An optoelectronic sensor for detecting objects in a monitored zone, having at least one transmission/reception module and having an evaluation unit, the transmission/reception module comprising:
a light transmitter having a transmission optics and
a light receiver having a reception optics, wherein an irradiation angle of transmitted light of the light transmitter is smaller than a reception angle of received light incident on the light receiver; the light transmitter and the light receiver are arranged coaxially; the transmission optics and the reception optics are formed as a common optics; and the light transmitter and the light receiver are micromechanically connected to one another; wherein the evaluation unit is configured to determine a time of flight from a received signal of the light receiver and to determine a spacing from an object detected in the monitored zone from it.

21. The optoelectronic sensor in accordance with claim 21, wherein the optoelectronic sensor is one of a light sensor and a light scanner.

22. A method of detecting objects in a monitored zone in which a light transmitter transmits transmitted light through a transmission optics into the monitored zone and a light receiver receives received light remitted with the transmitted light in the monitored zone by a reception optics, wherein an angle of irradiation of the transmitted light is smaller than an angle of reception of the received light; wherein the light transmitter and the light receiver are arranged coaxially; and wherein the transmission optics and the reception optics are configured as a common optics,
wherein at least some of the received light is received in the direct proximity of at most 500 μm from the location at which the transmitted light is irradiated in that the light transmitter and the light receiver are at least indirectly micromechanically connected to one another.
